(19) United States
(12) Patent Application Publication
(10) Pub. No.: US 2015/0215855 A1
(43) Pub. Date: Jul. 30, 2015

(54) APPARATUS FOR CELL SPECIFIC REFERENCE SIGNAL TRANSMISSION ON LTE SMALL CELL

(71) Applicant: Humax Holdings Co., Ltd., Yongin-si (KR)

(72) Inventors: Alex Chungku YIE, Incheon (KR); Yongjae Lee, Seongnam-si (KR); Jun Bae Ahn, Gwangju-si (KR)

(21) Appl. No.: 14/603,252

(22) Filed: Jan. 22, 2015

(30) Foreign Application Priority Data
Jan. 23, 2014 (KR) 10-2014-0008371
May 16, 2014 (KR) 10-2014-0058952
May 16, 2014 (KR) 10-2014-0058953
May 16, 2014 (KR) 10-2014-0058954
Aug. 14, 2014 (KR) 10-2014-0106098
Aug. 14, 2014 (KR) 10-2014-0106109
Aug. 19, 2014 (KR) 10-2014-0107901
Aug. 19, 2014 (KR) 10-2014-0107902
Aug. 19, 2014 (KR) 10-2014-0107904
Jan. 22, 2015 (KR) 10-2015-0010866

(51) Int. Cl. H04W 48/16; H04L 5/00

(52) U.S. Cl. CPC H04W 48/16; H04L 5/0048

(57) ABSTRACT

The present invention relates to a way of transmitting a cell specific reference signal to enable a terminal to reliably recognize a small cell base station. That is, the present invention relates to an apparatus for cell specific reference signal transmission on an LTE small cell which transmits a cell specific reference signal as a discovery signal and the apparatus includes a small cell base station that transmits a discovery reference signal to a terminal.

### BACKGROUND OF THE INVENTION

1. Field of the Invention

Exemplary embodiments of the present invention relate to an apparatus for cell specific reference signal transmission on an LTE small cell, and more particularly, to transmission of a cell specific reference signal to enable a terminal to reliably recognize a small cell base station. That is, exemplary embodiments of the present invention relate to an apparatus for cell specific reference signal transmission on an LTE small cell which transmits a cell specific reference signal as a discovery signal.

2. Description of the Related Art

With rapid propagation of mobile computing based on the wireless internet technology, it has been required to considerably increase a wireless network capacity and it is expected that the amount of traffic used by mobile users will rapidly increase. As a typical solution for satisfying requirements according to an explosive increase of traffic, a method of applying an evolved physical layer technology or allocating an additional spectrum may be considered. However, the physical layer technology has almost reached a theoretical limit and the method of increasing the capacity of a cellular network by allocating additional spectrums cannot be a basic solution.

Accordingly, as a method for efficiently supporting data traffic of users that is explosively increased in a cellular network, methods of providing a service by reducing the size of cells and densely installing more small cells or by using a multilayer cellular network have been studied.

For example, a “method and small cell base station for small cell access control” has been disclosed in Korean Patent Application Publication No. 10-2012-0138063. The method includes a step of receiving a call connection request from a first terminal in a small cell base station coverage of a small cell base station with the capacity fully used, a step of selecting an access control object terminal from the first terminal and a plurality of second terminals on the basis of signal quality information of the second terminals operating in the small cell base station coverage and the first terminal receiving the call connection request, and a step of controlling the access control object terminal so that the access control object terminal is moved to or induce to access a macrocell base station or another small cell base station.

However, there is always a possibility of degradation due to interference by other communication entities around in a communication environment with a macrocell base station and a plurality of small cell base stations. Accordingly, there is a need for a plan that can enable a terminal to discover small cell base stations with reliability for smooth communication with small cells around.

### DOCUMENTS OF RELATED ART

### Patent Document

Korean Patent Application Publication No. 10-2012-0138063 (Dec. 24, 2012)

### SUMMARY OF THE INVENTION

An object of the present invention is to provide an apparatus for cell specific reference signal transmission on an LTE small cell which transmits a cell specific reference signal so that a terminal reliably recognizes a small cell base station.

Another object of the present invention is to provide an apparatus for cell specific reference signal transmission on an LTE small cell which enables a terminal to effectively recognize a small cell base station by transmitting a cell specific reference signal as a discovery signal.

In accordance with an aspect of the present invention, an apparatus for cell specific reference signal transmission on an LTE small cell includes: an RF unit that transmits and receives wireless signals; and a processor that is connected with the RF unit, in which the processor transmits a discovery reference signal to a terminal on the basis of a cell specific reference signal.

When the apparatus is used as a sub-base station for the terminal, the processor may use ports for a discovery reference signal over the number of cell specific reference signal ports.

The processor may maintain one or more ports for a cell specific reference signal, even if a service is not provided.

The processor may inform the terminal of at least any one of the number of channel state recognition reference signal ports, the number of cell specific reference signal ports, and information about a transmission point recognition combination method.

The processor may transmit surrounding cell ID information (PCID) to the terminal, in measuring of a discovery reference signal (DRS) based on a cell specific reference signal (CRS), on the basis of at least any one of the number of terminals, the number of surrounding small cells, surrounding cell ID, interference by surrounding cells, interference by surrounding terminals, FDD operation, TDD operation, and whether there is a request from a terminal.

The processor may use any one of zeroth to sixteenth antenna ports.

The processor may transmit the discovery reference signal through any one of zeroth to sixteenth antenna ports on the basis of a cell specific reference signal.

The apparatus for cell specific reference signal transmission on an LTE small cell according to the present invention can transmit a cell specific reference signal to enable a terminal to reliably recognize a small cell base station.

Further, The apparatus for cell specific reference signal transmission on an LTE small cell according to the present invention can enable a terminal to effectively recognize a small cell base station by transmitting a cell specific reference signal as a discovery signal.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating the configuration of an LTE network according to an exemplary embodiment of the present invention;

FIG. 2 is a diagram illustrating the configuration of dual connectivity when a first base station of FIG. 1 operates as a main base station and a second base station operates independently as a sub-base station;

FIG. 3 is a diagram illustrating the configuration of dual connectivity when the first base station of FIG. 1 operates as a main base station, the second base station operates as a sub-base station, and data is separated and combined through the main base station;

FIG. 4 is a diagram illustrating a configuration in detail when the sub-base station of FIGS. 2 and 3 is disconnected from a terminal;

FIG. 5 is a diagram illustrating a configuration in detail when transmission power for a terminal is allocated to the main base station or the sub-base station of FIGS. 2 and 3;

FIG. 6 is a diagram illustrating a configuration in detail when a terminal randomly accesses the main base station or the sub-base station of FIGS. 2 and 3;

FIG. 7 is a diagram illustrating a method of increasing the performance of a terminal in an area concentrated with small cell base stations according to another exemplary embodiment of the present invention;

FIG. 8 is a diagram showing the configuration of the small cell base station of FIG. 7 transmitting a discovery reference signal;

FIG. 9 is a diagram showing the small cell base station of FIG. 7 transmitting a cell specific reference signal port information to a terminal;

FIG. 10 is a diagram showing the small cell base station of FIG. 7 transmitting CRS-based DRS information; and

FIG. 11 is a block diagram illustrating a wireless communication system for which exemplary embodiments of the present invention can be achieved.

### DESCRIPTION OF SPECIFIC EMBODIMENTS

Detailed exemplary embodiments of the present invention will be described with reference to the accompanying drawings.

The present invention may be modified in various ways and implemented by various exemplary embodiments, so that specific exemplary embodiments are illustrated in the drawings and will be described in detail below. However, it is to be understood that the present invention is not limited to the specific exemplary embodiments, but includes all modifications, equivalents, and substitutions included in the spirit and the scope of the present invention.

Hereinafter, an apparatus for on-off information transmission on an LTE small cell according to the present invention is described in detail with reference to the accompanying drawings.

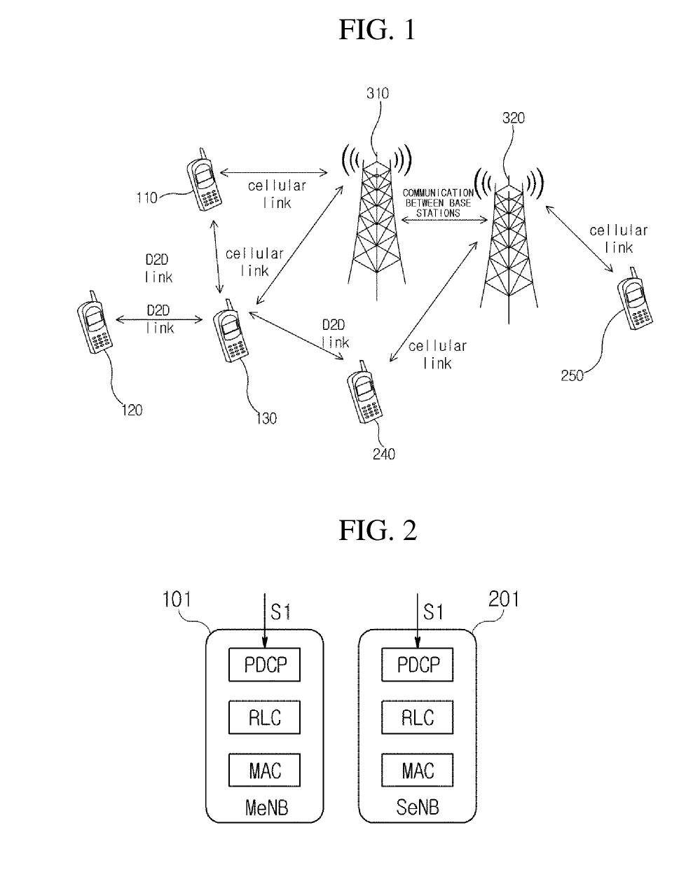

FIG. 1 is a diagram illustrating the configuration of an LTE network according to an exemplary embodiment of the present invention and FIGS. 2 to 6 are diagrams illustrating the configuration of FIG. 1 in detail.

An apparatus for transmitting/receiving on/off information of an LTE small cell according to an exemplary embodiment of the present invention is described hereafter with reference to FIGS. 1 to 6.

Referring to FIG. 1 first, an LTE network structure according to an exemplary embodiment of the present invention is composed of base stations and terminals. In particular, new frequencies can be allocated and used for inter-terminal communication, when a macrocell and a D2D channel are specifically allocated.

When a macrocell and a D2D channel are both allocated, inter-terminal communication may be achieved by at least any one of adding a sub-channel and using the physical channel used by the macrocell, and at least any one of a channel allocation scheme, a channel management scheme, and a duplexing method may be used for interference between the macrocell and the D2D channel.

Further, synchronization between terminals may be provided from at least any one of an uplink, a downlink, and both of an uplink and a downlink.

In the LTE network structure, in detail, a first terminal 110 and a third terminal 130 are in the cellular link coverage of a first base station 310, and a fourth terminal 240 and a fifth terminal 250 are in the cellular link coverage of a second base station 320.

The third terminal 130 is positioned at a distance where D2D communication with the first terminal 110, the second terminal 120, and the fourth terminal 240 is available. The D2D link of the third terminal 130 and the first terminal 110 is in the same first base station 310, the D2D link of the third terminal 130 and the fourth terminal 240 is on another cellular coverage, the D2D link of the third terminal 130 and the second terminal 120 is formed by the second terminal 120 not positioned in any cellular coverage and the third terminal 130 positioned in the cellular coverage of the first base station 310.

The cellular link channel used between the first base station 310 and the third terminal 130 and the D2D link channel used by the third terminal 130 and the fourth terminal 240 may be separately or simultaneously allocated.

For example, when the cellular link channel used between the first base station 310 and the third terminal 130 and the D2D link channel used by the third terminal 130 and the fourth terminal 240 use the same frequency, OFDM symbols of PDSCH, PDCCH, PUSCH, and PUCCH may be separately allocated.

In particular, the first base station 310 can carry out an allocation schedule of time slots for transmitting a synchronization signal, a discovery signal, and an HARQ for the D2D link channel used by the third terminal 130 and the fourth terminal 240.

The synchronization signal transmitted by the first base station 310 may be used simultaneously with the information about the cellular link of the first base station 310, but the time slots for transmitting a synchronization signal, a discovery signal, and an HARQ for the third terminal 130 and the fourth terminal 240 may be scheduled not to overlap the time slots of the cellular link channels used between the first base station 310 and the third terminal 130.

When the cellular link channel used between the first base station 310 and the third terminal 130 and the D2D link channel used by the third terminal 130 and the fourth terminal 240 use different frequencies, the third terminal 130 and the fourth terminal 240 can exclusively use the OFDM symbols of PDSCH, PDCCH, PUSCH, and PUCCH, and the third terminal 130 or the fourth terminal 240 can perform scheduling.

D2D communication between the third terminal 130 and the fourth terminal 240 is performed, avoiding interference influenced by the first base station 310 and the first terminal 110. In particular, in the D2D communication between the third terminal 130 and the fourth terminal 240, the third terminal 130 uses any one of a way of transmitting a synchronization signal received from the first base station 310 to the fourth terminal 240 through the uplink channel used by the first base station 310, a way of transmitting the synchronization signal to the fourth terminal 240 through the downlink channel used by the first base station 310, and a way of transmitting the synchronization signal to the fourth terminal 240 through both of the uplink and downlink channels used by the first base station 310.

Elements for D2D data communication are described hereafter with reference to another exemplary embodiment.

FIG. 2 is a diagram illustrating a configuration of dual connectivity when the first base station 310 of FIG. 1 operates as a main base station 101 and the second base station 320 operates independently as a sub-base station 201.

The main base station 101 (master eNB) and the sub-base station 201 (secondary eNB), which are used for dual connectivity, are individually connected with a core network.

Accordingly, all of protocols are independent from the main base station 101 and the sub-base station 201, and particularly, data to be transmitted to two base stations is not separated and combined at the base stations.

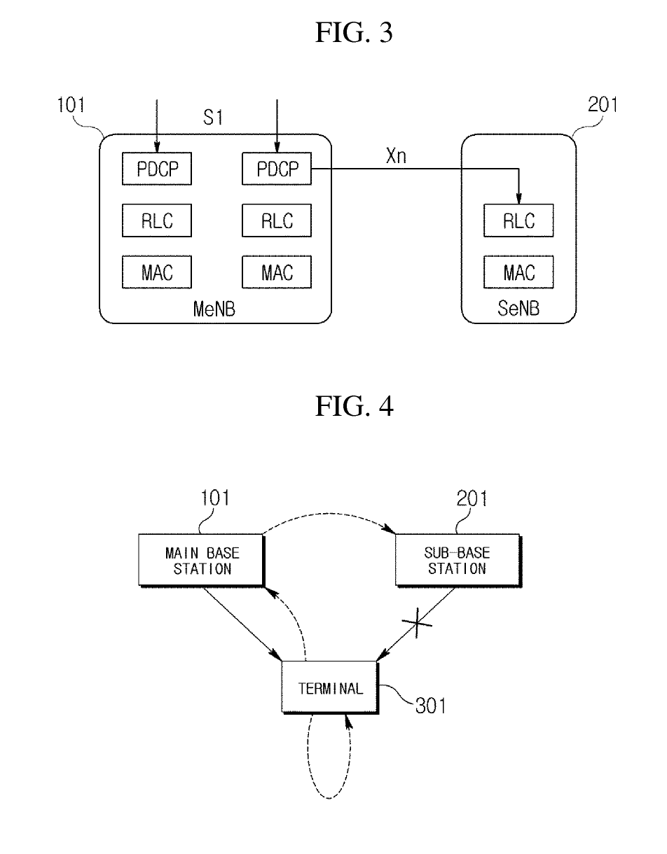

FIG. 3 is a diagram illustrating a configuration of dual connectivity when the first base station 310 of FIG. 1 operates as a main base station 101, the second base station 320 operates as a sub-base station 201, and data is separated and combined through the main base station 101, in which only the main base station is connected with a core network and separates and combines data from the core network.

FIG. 4 is a diagram illustrating a configuration in detail when the sub-base station 201 of FIGS. 2 and 3 is disconnected from a terminal 301.

That is, the apparatus for transmitting/receiving on/off signal of an LTE small cell includes the main base station 101 that allocates a radio resource to the terminal 301 and performs data communication with the terminal 301, the sub-base station 201 that performs data communication with the terminal 301 simultaneously with the main base station 101, and the terminal 301 that simultaneously performs data communication with the main base station 101 and the sub-base station 201, and resets radio resource control when it unlinks from the sub-base station 201.

When the terminal 301 is not normally connected with the sub-base station 201, it informs the main base station 101 of connection state information and the main base station 101 informs the sub-base station 201 of the link state information between the sub-base station 201 and the terminal 301.

Similarly, when the terminal 301 is abnormally connected with the main base station 101, the terminal 301 resets radio resource control and reports it to the sub-base station 201 and the sub-base station 201 reports the abnormal connection to the main base station 101.

The communication between the main base station 101 and the sub-base station 201 may be performed by adding information to a frame in an X2 interface or by a broadband network, and when they are not connected by a wire, wireless backhaul may be used for the communication. A signal system including a link state header showing the link state of the main base station 101 and the sub-base station 201, a link state, a base station ID, and a terminal ID may be used for the information in the frame.

Accordingly, when there is a problem with connection in any one of the main base station 101 and the sub-base station 201, the terminal 301 reports it to any one of the main base station 101 and the sub-base station 201, which has no problem, and the base station receiving the report informs the base station with the problem with connection of the report so that the state of connection with the terminal 301 can be checked.

On the other hand, when there is a problem with connection in both of the main base station 101 and the sub-base station 201, similarly, the terminal 301 resets the radio resource control to allow for communication with the base stations.

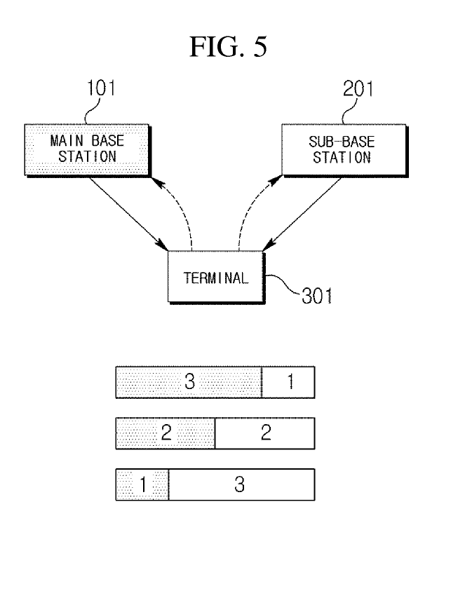

FIG. 5 is a diagram illustrating a configuration in detail when transmission power for the terminal 301 is allocated to the main base station 101 or the sub-base station 201 of FIGS. 2 and 3.

That is, the apparatus for transmitting/receiving on/off information of an LET small cell includes the main base station 101 that allocates a radio resource to the terminal 301 and performs data communication with the terminal 301, the sub-base station 201 that performs data communication with the terminal 301 simultaneously with the main base station 101, and the terminal 301 that sets an upper limit ratio of transmission power for the main base station 101 and the sub-base station 201 on the basis of statistic analysis on power sent out from the main base station 101 and the sub-base station 201.

The statistic analysis is analyzing a transmission power ratio on the basis of the average power sent out from the terminal 301 to the main base station 101 and the sub-base station 201, and the terminal 301 reports the upper limit ratio of transmission power to the main base station 101 and the sub-base station 201.

That is, the terminal 301 sets the power ratio to send out to the main base station 101 and the sub-base station 201 on the basis of the average value of the maximum power, which can be sent out by the terminal 301, and the transmission values sent out to the main base station 101 and the sub-base station 201.

For example, it sets the ratio of power to send out to the main base station 101 and the sub-base station 201 as 3:1, 2:2, and 1:3.

As another example, when power to be sent is distributed, first, it is very important to maintain connectivity with the main base station 101 or transmit a control signal, so, in order to transmit the signal, power may be allocated to the main base station 101 first and then the remaining power may be distributed for data transmission/reception with the sub-base station 201.

As another example, the power available for transmitting data to the sub-base station 201 may be dynamically changed. That is, an MCS (Modulation and Coding Scheme) value may depend on the available power, even if the wireless channel does not change.

A data transmission error may be generated, when the power distribution and the MCS value are simultaneously changed, so that a change of the power distribution and a change of the MCS value may not be simultaneously performed.

Alternatively, when the power distribution and the MCS value are simultaneously changed, a period of reporting a CQI (Channel Quality Indicator) for changing the MCS, which is a feedback signal system, may be set not to be generated simultaneously with the change of the power distribution, in order to prevent a data transmission error.

On the other hand, at least any one of the maximum value of a terminal, the ratio of power that is being used, the maximum transmission power for each base station according to a power ratio, and the margin of the maximum power, which can be transmitted to the base stations, to the power currently sent out to the terminal can be reported to the main base station 101 and the sub-base station 201.

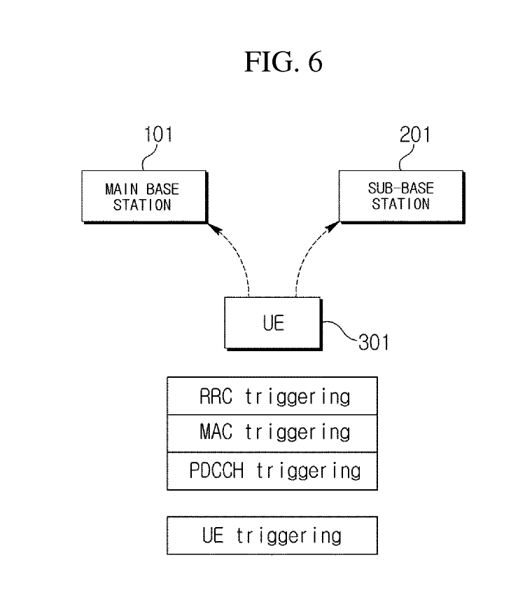

FIG. 6 is a diagram illustrating a configuration in detail when the terminal 301 randomly accesses the main base station 101 or the sub-base station 201 of FIGS. 2 and 3.

That is, the apparatus for transmitting/receiving on/off information of an LTE small cell includes the main base station 101 that allocates a wireless resource to the terminal 301 and performs data communication with the terminal 301, the sub-base station 201 that performs data communication with the terminal 301 simultaneously with the main base station 101, and the terminal 301 that sends out any one of random access to the main base station 101 and the sub-base station 201 by triggering and self random access to them without triggering to at least any one of the main base station 101 and the sub-base station 201.

The triggering is performed by any one triggering command of PDCCH, MAC, and RRC and the sub-base station 201 includes a base station, which can be accessed first, of base stations that can operate as the sub-base station 201.

The random access is transmitted in any one type of a preamble without contents, initial access, a wireless resource control message, and a terminal ID>

That is, the random access, which is used for initial access to the main base station 101 or the sub-base station 201, establishment and re-establishment of wireless resource control, and handover, may be sent out to any one of the main base station 101 and the sub-base station 201 or simultaneously to the main base station 101 or the sub-base station 201.

Random access may be sent out by PDCCH, MAC, and RRC (Radio Resource Control) triggering from the main base station 101 or the sub-base station 201, but it may be sent out by triggering of a terminal itself.

Further, random access may be sent out by using the remaining power except for the power distributed to an uplink.

On the other hand, when the main base station 101 or the sub-base station 201 is newly turned on, an error may be generated in data communication due to simultaneous random access of surrounding terminals, including the terminal 301.

Accordingly, in order to reduce such influence, the terminal 301 may perform random access, additionally using a random time around ten seconds, when the main base station 101 or the sub-base station 201 is newly turned on. The ‘ten seconds’ is the maximum random access time that is variable in accordance with the number of terminals and the number of base stations and the maximum random access time may be any one in the range of one second to sixty seconds, depending on the environment.

Meanwhile, since the terminal 301 can use a multi-antenna, it is possible to minimize interference influence by finding the transmission position of the main base station 101 or the sub-base station 201 and performing random access toward the main base station 101 or the sub-base station 201.

Alternatively, when the exact positions of the main base station 101 and the sub-base station 201 are not found, the terminal 301 may perform random access by sweeping at 360 degrees.

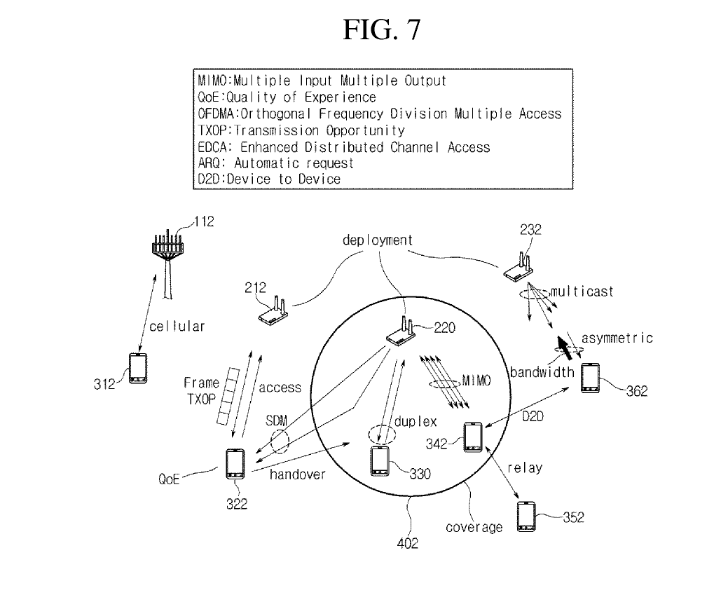

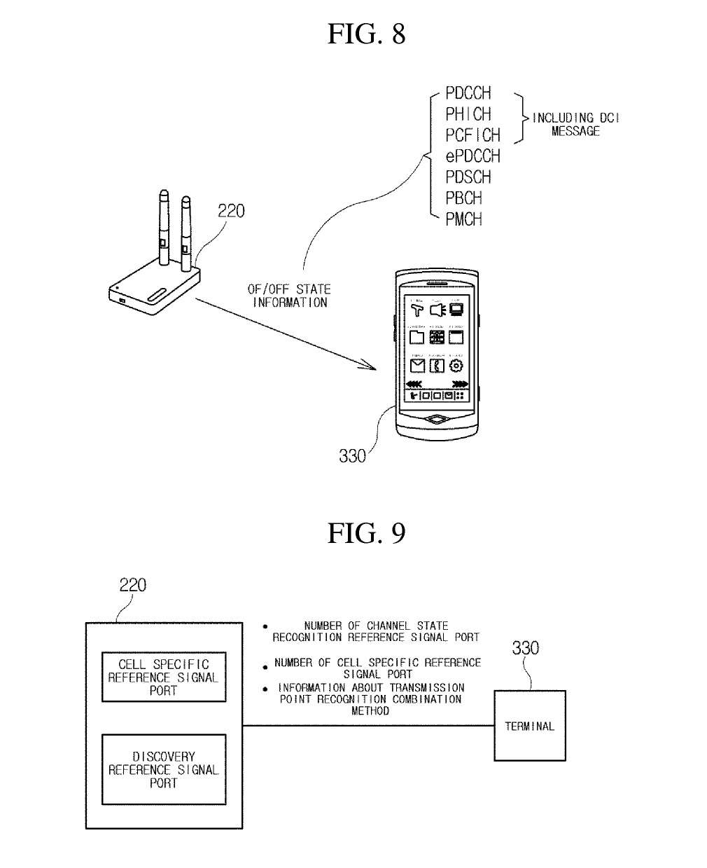

FIG. 7 is a diagram illustrating a method of increasing the performance of a terminal in an area concentrated with small cell base stations according to another exemplary embodiment of the present invention and FIG. 8 is a diagram showing a configuration for illustrating the configuration of FIG. 7 in detail.

An apparatus for transmitting/receiving on/off information of an LTE small cell according to another exemplary embodiment of the present invention is described hereafter with reference to FIGS. 7 and 8.

Referring to FIG. 7, a method of increasing the performance of a terminal according to another exemplary embodiment of the present invention includes at least any one of a cellular interference removal technique that reduces cellular interference between a base station 112 and a terminal 312, a frame rearrangement technique that efficiently uses the frame between a small cell base station 212 and a terminal 322, a TXOP (Transmit OPportunity) technology that schedules a transmission opportunity between the small cell base station 212 and the terminal 322, an efficient access technique that makes a method of accessing the small cell base station 212 from the terminal 322 efficient, an SDM (Spatial Domain Multiplexing) technique that improves the quality of service provided for the terminal 322 by spatially disposing an antenna between a small cell base station 220 and the terminal 322, an efficient handover technique that ensures efficient conversion when the terminal 322 in the service coverage of the small cell base station 212 enters the service area of the small cell base station 220 and converts small cell base station connection, an efficient duplex technique that uses more efficiently a duplex way between the small cell base station 220 and the terminal 330, an MIMO (Multiple Input Multiple Output) technique that improves data performance of a terminal 342, using several antennas between the small cell base station 220 and the terminal 342, a relay technique in which the terminal 342 within the service range of the small cell base station 220 relays the information about the small cell base station 220 to a terminal 352 out of the service coverage of the small cell base station 220, a D2D (Device to Device) technique that performs direct communication between the terminal 342 and a terminal 362, an asymmetric technique that efficiently and differently uses the bandwidths of UL and DL between a small cell base station 232 and the terminal 362, a bandwidth technique that adjusts the bandwidth between the terminal 362 and the small cell base station 232, and a multicast technique that transmits the same data to common users from the small cell base station 232.

The small cell base station 220 may transmit PSS (Primary Synchronization Signal), PSS/SSS (Secondary Synchronization Signal), CRS (Cell Specific Reference Signal), CSI-RS (Channel State Indicator-Reference Signal), and PRS to the terminal 330.

Then, PSS, PSS/SSS, CRS, CSI-RS, and PRS signals may be used for measuring time synchronization, frequency synchronization, Cell/TP (Transmission Points) identification, and RSRP (Reference Signal Received Power). CSI-RS is not used for the time synchronization, but RSSI measuring a symbol including/not including a discovery signal is used for measuring RSRQ (Reference Signal Received Power).

The measurement of RSRP and RSRQ may be used in various cases such as muting in a transmitter, and interference removal may be considered in a receiver.

UE can detect several cells by setting a DRS for one frequency and may perform RSRP measurement based on a CRS and RSRP measurement based on a CSI-RS.

The UE can set DRS measurement time per frequency. The setting of DRS measurement time means setting time that the UE takes to perform cell detection or perform RRM measurement on the basis of a DRS. The setting of DRS measurement time includes the minimum period, offset to serving cell, and the maximum available measurement width.

A DRS may be used as a kind of PSS/SSS of rel-8 and may be achieved by setting a variety of CSI-RSs. Setting of various CSI-RSs may be or may not be in the same sub-frame and may be different independent scrambles.

A CRS used as a DRS may be transmitted to the same frame at least as a PSS/SSS and may not be transmitted continuously with a CSI-RS.

Further, an SSS used as a DRS may be changed in offset in setting of CSI-RE or may be fixed within 5 msec, in which five or less DRSs may be continuously configured.

The scramble ID of an PSS/SSS/CRS that is used as a DRS is a PCID, but the scramble ID of a CSI-RS is different from a PCID. Further, TP identification may be expressed by setting of CSI-RS RE, a scramble ID, sub-frame offset, a cover code or combination of them.

A DRS may be transmitted in a DL sub-frame or in DwPTS area of a sub-frame. Further, a DRS may be transmitted to MB SFN sub-frame and the DRS level may be designed in consideration of trade-off with surrounding interference such as a synchronization level, the number of times of reuse, and the total reception power to planning in a base station.

FIG. 8 is a diagram showing the configuration of the small cell base station 220 of FIG. 7 transmitting a discovery reference signal. The apparatus for cell specific reference signal transmission on an LTE small cell includes a small cell base station 220 that transmits a discovery reference signal to a terminal 330.

When the small cell base station 220 is used as a sub-base station for the terminal 330, on-off information of the small cell base station 220 may be transmitted to the terminal 330 through a PDCCH, a PHICH, or a PCFICH including a DCI message or through channels such as an ePDCCH, a PDSCH, a PBCH, or a PMCH.

The small cell base station 220 may transmit a broadcast message to the terminal 330 through a PDCCH, a PHICH, or a PCFICH including a DCI message, or through channels such as a PDSCH, a PBCH, or a PMCH.

That is, the DCI (Downlink Control Information) is information carrying a scheduler and a hybrid ARQ protocol. The DCI is transmitted through a PDCCH (Physical Downlink Control Channel) that is a downlink control channel, a PHICH (Physical Hybrid ARQ Indicator Channel) that is an exclusive channel for downlink hybrid ARQ, or a PCFICH (Physical Control Format Indicator Channel) for transmitting decoding information of the PDCCH.

Meanwhile, the ePDCCH (Enhanced PDCCH) a channel with an additional function in the PDCCH, the PDSCH is a channel for transmitting data or paging information to one terminal 330, and the PBCH (Physical Broadcast Channel) and the PMCH (Physical Multicast Channel) are a broadcast channel and a multicast channel, respectively.

FIG. 9 is a diagram showing the small cell base station of FIG. 7 transmitting a cell specific reference signal port information to a terminal.

When the small cell base station 220 is used as a sub-base station for the terminal 330, it may use ports for a discovery reference signal over the number of cell specific reference signal ports.

When the small cell base station 220 does not service, the number of ports of a cell specific reference signals can be maintained at one or more.

The small cell base station 220 may inform the terminal 330 of at least any one of the number of channel state recognition reference signal ports, the number of cell specific reference signal ports, and information about a transmission point recognition combination method.

That is, the small cell base station 220 may inform the terminal 330 of at least any one of the number of channel state recognition reference signal ports, the number of cell specific reference signal ports, and information about a transmission point recognition combination method, in which at least any one of cell specific reference signal ports is maintained, and when the small cell base station 220 is used as a sub-base station for the terminal 330, ports of a discovery reference signal over the number of cell specific reference signal ports may be used.

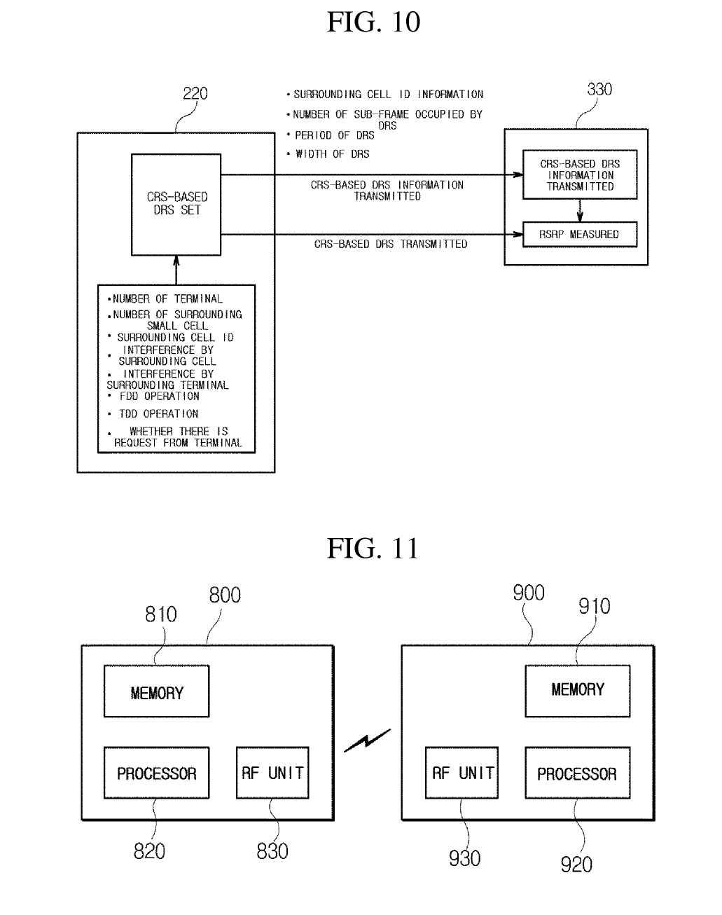

FIG. 10 is a diagram showing the small cell base station of FIG. 7 transmitting CRS-based DRS information.

The small cell base station 220 may set at least any one of the number, period, and width of sub-frames occupied by a cell specific reference signal on the basis of at least any one of the number of terminals, the number of surrounding small cells, interference by surrounding cells, interference by surrounding terminals, FDD operation, TDD operation, and whether there is a request from a terminal.

Further, the small cell base station 220 can transmit surrounding cell ID information (PCID: Physical Cell ID), the number of sub-frames occupied by a DRS, a DRS period, and a DRS width to the terminal 330, in measuring of a discovery reference signal (DRS) based on a cell specific reference signal (CRS) on the basis of at least any one of the number of terminals, the number of surrounding small cells, surrounding cell ID, interference by surrounding cells, interference by surrounding terminals, FDD operation, TDD operation, and whether there is a request from a terminal.

The cell specific reference signal (CRS) may be used as one for a method of measuring a discovery reference signal (DRS) and may be used for synchronizing frequencies and measuring RSRP and RSRQ. Further, the information about surrounding small cells can find out the number of surrounding small cells, interference by surrounding cells, and interference by surrounding terminals on the basis of the surrounding cell ID. The small cell base station 220 can transmit information such as the number, period, and width of sub-frames where a cell specific reference signal (CRS) may be positioned, together with the surrounding cell ID information (PCID), to the terminal 330.

Further, the small cell base station 220 can transmit a discovery reference signal through any one of zeroth to sixteenth antenna ports on the basis of a cell specific reference signal.

For example, a zeroth discovery reference signal port and a first discovery reference signal port may be used for measuring RSRP.

First, if the terminal 330 can reliably detect existence of the zeroth discovery reference signal port out of the area of DMTC (DRS measurement timing configuration) in a carrier frequency, the terminal 330 may use the zeroth discovery reference signal port out of the DMTC in order to measure the RSRP of the cell.

Second, if the terminal 330 can reliably detect existence of the first discovery reference signal port in a carrier frequency, the terminal 330 may use the first discovery reference signal port in order to measure the RSRP of the cell.

Further, the terminal 330 can receive information about the width of discovery occupation at one carrier frequency and it is the same for all of small cells at one carrier frequency. For example, a sub-frame occupied by a discovery reference signal may be any one of first one to fifth one in FDD, and it may be any one of second one to fifth one in TDD.

FIG. 11 is a block diagram illustrating a wireless communication system for which exemplary embodiments of the present invention can be achieved.

The wireless communication system shown in FIG. 11 may include at least one base station 800 and at least one terminal 900.

The base station 800 may include a memory 810, a processor 820, and an RF unit 830. The memory 810 is connected with the processor 820 and can keep commands and various terms of information for activating the processor 820. The RF unit 830 is connected with the processor 820 and can transmit/receive wireless signals to/from an external entity. The processor 820 can execute the operations of the base stations in the embodiments described above. In detail, the operations of the base stations 100, 101, 112, 200, 201, 212, 220, 232, 310, and 320 etc. in the embodiments described above may be achieved by the processor 820.

The terminal 900 may include a memory 910, a processor 920, and an RF unit 930. The memory 910 is connected with the processor 920 and can keep commands and various terms of information for activating the processor 920. The RF unit 930 is connected with the processor 920 and can transmit/receive wireless signals to/from an external entity. The processor 920 can execute the operations of the terminals in the embodiments described above. In detail, the operations of the terminals 110, 120, 130, 240, 250, 300, 312, 322, 330, 342, 352, and 362 etc. in the embodiments described above may be achieved by the processor 920.

The present invention may be modified in various ways and implemented by various exemplary embodiments, so that specific exemplary embodiments are shown in the drawings and will be described in detail.

However, it is to be understood that the present invention is not limited to the specific exemplary embodiments, but includes all modifications, equivalents, and substitutions included in the spirit and the scope of the present invention.

Terms used in the specification, ‘first’, ‘second’, etc., may be used to describe various components, but the components are not to be construed as being limited to the terms. The terms are used to distinguish one component from another component. For example, the ‘first’ component may be named the ‘second’ component, and vice versa, without departing from the scope of the present invention. The term ‘and/or’ includes a combination of a plurality of items or any one of a plurality of terms.

It should be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, numerals, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

In one or more exemplary embodiments, the described functions may be achieved by hardware, software, firmware, or combinations of them. If achieved by software, the functions can be kept or transmitted as one or more orders or codes in a computer-readable medium. The computer-readable medium includes all of communication media and computer storage media including predetermined medial facilitating transmission of computer programs from one place to another place.

If achieved by hardware, the functions may be achieved in one or more ASICs, DSPs, DSPDs, PLDs, FPGAs, processors, controllers, microcontrollers, microprocessors, other electronic units designed to perform the functions, or combinations of them.

If achieved by software, the functions may be achieved by software codes. The software codes may be kept in memory units and executed by processors. The memory units may be achieved in processors or outside processors, in which the memory units may be connected to processors to be able to communicate by various means known in the art.

Although the present invention was described above with reference to exemplary embodiments, it should be understood that the present invention may be changed and modified in various ways by those skilled in the art, without departing from the spirit and scope of the present invention described in claims.

What is claimed is:

1. An apparatus for cell specific reference signal transmission on a small cell, the apparatus comprising:
an RF unit that transmits and receives wireless signals; and
a processor that is connected with the RF unit,
wherein the processor transmits a discovery reference signal to a terminal on the basis of a cell specific reference signal.

2. The apparatus of claim 1, wherein when the apparatus is used as a sub-base station for the terminal, the processor uses ports for a discovery reference signal over the number of cell specific reference signal ports.

3. The apparatus of claim 1, wherein the processor maintains one or more ports for a cell specific reference signal, even if a service is not provided.

4. The apparatus of claim 1, wherein the processor informs the terminal of at least any one of the number of channel state recognition reference signal ports, the number of cell specific reference signal ports, and information about a transmission point recognition combination method.

5. The apparatus of claim 1, wherein the processor transmits surrounding cell ID information (PCID) to the terminal, in measuring of a discovery reference signal (DRS) based on a cell specific reference signal (CRS), on the basis of at least any one of the number of terminals, the number of surrounding small cells, surrounding cell ID, interference by surrounding cells, interference by surrounding terminals, FDD operation, TDD operation, and whether there is a request from a terminal.

6. The apparatus of claim 1, wherein the processor uses any one of zeroth to sixteenth antenna ports.

7. The apparatus of claim 1, wherein the processor transmits the discovery reference signal through any one of zeroth to sixteenth antenna ports on the basis of a cell specific reference signal.
